(19) United States
(12) Patent Application Publication
(10) Pub. No.: US 2005/0138367 A1
(43) Pub. Date: Jun. 23, 2005

(54) System and method for storing user credentials on a server copyright notice

(76) Inventors: Robert Paganetti, Scituate, MA (US); Alan Eldridge, Hollis, NH (US); Charles Kaufman, Sammamish, WA (US); Mary Ellen Zurko, Groton, MA (US); Katherine Ann Emling, Woburn, MA (US); Richard Blair Davies JR., Wayland, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/741,669

(22) Filed: Dec. 19, 2003

(51) Int. Cl. H04L 9/00

(52) U.S. Cl. 713/161

(57) ABSTRACT

The invention relates generally secure mail operations. More particularly, the invention provides a method for managing a user security credential, the method comprising: storing, in a file contained in a data store communicatively coupled to a mail server, a security credential associated with a user; authorizing a client to access the data store according to an access permission associated with the user; retrieving the security credential from the file; and initiating a security-related mail operation from the client using the security credential without the security credential leaving the server.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The invention disclosed herein relates generally to storing user security credentials on a server and more particularly to storing and using user security credentials in data stores on a server for use by remote clients.

E-mail messages, file transfers, packet traffic, and other types of electronic information are frequently communicated between networked systems and electronic data transfer is an inherent aspect of networked environments. E-mail particularly has become an extremely popular means of communication and people send millions of messages over the Internet every day.

While e-mail has simplified and expanded communications between networked users, communication security has also become an important concern. As more and more users become familiar with e-mail and use e-mail to send everyday communications, it becomes increasingly evident that many users, especially business and government users, are also using e-mail to transmit sensitive information. For these users, security concerns often require that only designated recipients be able to read certain e-mails. Additionally, these users also need to rely on or trust that a particular message was really communicated by a particular sender and is not a forgery. Unfortunately, one drawback associated with electronic communications, and e-mail systems generally, is that electronic communications are extremely susceptible to interception and forgery unless proper security precautions are enacted.

One method used to secure electronic communications, such as e-mails, is the Secure Multi-Purpose Internet Mail Extensions (“S/MIME”) protocol. The S/MIME protocol is further described in RFC 2311, 2312, 2632, 2633, and 2634, each of which is hereby incorporated herein by reference in its entirety. S/MIME is a secure method of sending e-mail that uses the Rivest-Shamir-Adleman (“RSA”) encryption system, though those skilled in the art will recognize that any encryption scheme supporting similar functionality could be employed to secure electronic communications and data transfers. For example, PGP/MIME is another secure mail protocol proposed as an alternative to S/MIME which could also be used to support the functionality of the systems further described herein. Using RSA encryption techniques, S/MIME embeds digital tokens, such as digital signatures or certificates, in e-mails and these digital tokens can be used to authenticate the identity of a sender. As further described herein, RSA and other encryption schemes can also be used to scramble or encrypt the contents of an e-mail messages thus rendering them secure against interception by someone other than the designated recipient.

RSA is a type of public key infrastructure (“PKI”) encryption scheme which uses two types of keys, public keys and private keys, to secure electronic communications. Public key infrastructure systems are well known in the art. As further described herein, a user's public key is available to anyone for use in performing security-related operations, but a user's private key is only available to the user. Thus, if a user wants to ensure against forgery by digitally signing a message indicating that they are the actual sender, the user “signs” the message with a cryptographic signature also including a digital certificate generated with the user's public key and embeds this digital certificate in the message itself. The digital certificate serves as a verifiable credential that can be decoded to validate the user's identity. A digital certificate generally contains various information such as the certificate holder's name or serial number, the certificate's expiration date, the certificate holder's public key, the digital signature of the certificate by the issuing authority (“CA”), the issuing authority name, and other similar information known in the art. Digital certificates are generally issued or created by a certificate-issuing authority that creates the certificate using the user's public key. In some instances, the CA is also responsible for issuing the user their public and private keys. Thus, recipients are able to verify the cryptographic signature by decoding the digital certificate and verifying trust to it.

Users can also use PKI systems to encrypt and secure communications against interception. Thus, a user can encrypt a communication, such as an e-mail, using the public key of the intended recipient. The encrypted e-mail can then only be decrypted using the recipient's corresponding private key of the public/private key pair.

One problem associated with use of PKI systems and other encryption schemes in existing e-mail systems is that much of the encryption functionality is located at a user's personal e-mail client computer. A user's public key is, by definition, generally available to all via a public directory or other means, however, a user's private key usually resides on the user's personal mail client computer or the user may carry their private key on their person, for example on a digital key ring or other similar device. This creates a problem when a user desires to perform a security-related mail operation at a computer other than the computer storing the user's private key. For example, browser-based mail systems have become increasingly popular allowing users to logon and perform e-mail operations from any computer connected to the Internet or other similar network. Without access to their private key, however, a user cannot securely sign mail, verify mail, or decrypt encrypted mail.

There is thus a need for systems and methods which permit users to perform security-related e-mail operations at computers other than their own personal mail client computer.

### SUMMARY OF THE INVENTION

The present invention addresses, among other things, the problems discussed above with to storing user security credentials on a server and more particularly to storing and using user security credentials in a data store on a server for use by remote clients without the credentials ever leaving the server.

In accordance with some aspects of the present invention, computerized methods are provided for managing a user security credential, the method comprising: storing, in a file contained in a data store communicatively coupled to a mail server, a security credential associated with a user; authorizing a client to access the data store according to an access permission associated with the user; retrieving the security credential from the file; and initiating a security-related mail operation from the client using the security credential without the security credential leaving the server. For example, the security credential is not transmitted to the client to perform the security-related mail operation; instead, the credential is used at the server to perform the security-related mail operation.

In some embodiments, the file contains an identifier indicating that a security credential is stored in the file. The security credential may comprise a private key associated with a user, a digital certificate associated with a user, or a cross-certificate associated with a user according to embodiments of the invention.

In some embodiments, the client comprises a remote mail client, for example, a remote mail client operating via a browser. In some embodiments, a user at the client (manually or via their software agent) instructs the mail server to parse the file and retrieve the security credential. The user may then use the credentials to sign, encrypt, verify, or both sign and encrypt the electronic mail message according to embodiments of the invention.

In some embodiments, a system is provided for managing a user security credential, the system comprising: a file containing a security credential associated with a user; a data store containing the file and communicatively coupled to a mail server; an electronic mail program executing on the mail server; and a client computer; wherein the electronic mail program is programmed to: authorize the client computer to access the data store according to an access permission associated with the user; retrieve the security credential from the file; and initiate a security-related mail operation from the client using the security credential without the security credential leaving the server.

In some embodiments, a computer usable medium or media storing program code is provided which, when executed on a computerized device, causes the computerized device to execute a method for managing a user security credential, the method comprising: storing, in a file contained in a data store communicatively coupled to a mail server, a security credential associated with a user; authorizing a client to access the data store according to an access permission associated with the user; retrieving the security credential from the file; and initiating a security-related mail operation from the client using the security credential without the security credential leaving the server.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flow chart of method for managing a user security credential according to an embodiment of the present invention;

FIG. 2 is a block diagram of a system for managing a user security credential according to an embodiment of the present invention; and

FIG. 3 is a flow chart of a method for managing a user security credential according to an embodiment of the present invention.

### DETAILED DESCRIPTION

Preferred embodiments of the invention are now described with reference to the drawings. As described further below, systems and methods are presented for managing user security credentials, particularly PKI user key pairs in an e-mail system.

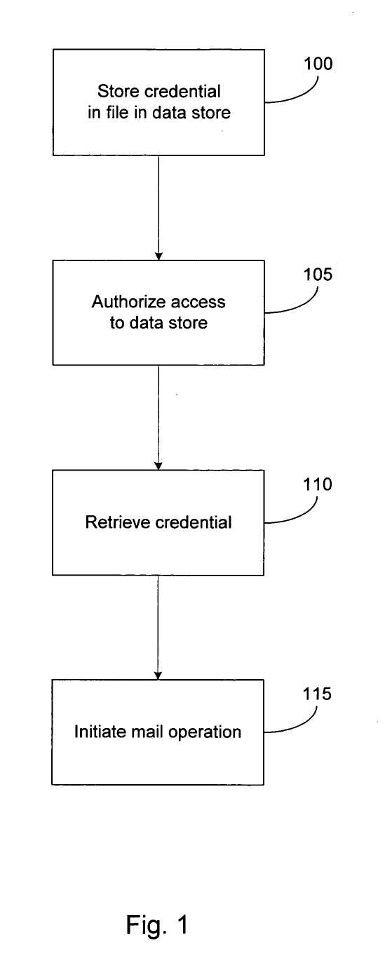

FIG. 1 presents a flow chart of method for managing a user security credential according to an embodiment of the present invention. A user's credentials are stored in a file in a data store, step 100. For example, a user's security credentials, such as their private key or their public and private key pair are stored in a mail database file or in an e-mail in the data store. In some embodiments, the credentials are stored in the mail database file as an attachment, while in other embodiments, they are embedded directly in the mail message itself as plain text, ASCII, etc. In some embodiments, the system includes means for generating the security credentials, for example generating a user key pair, as known in the art. In other embodiments, the security credential(s) already exist or are generated by other programs/systems and are only stored in the file in the data store.

The data store is generally communicatively coupled to a central mail server or other application which the user can access from remote clients (e.g.—in addition to accessing from their own personal e-mail client computer). Thus, to use the security credential, the system authorizes access to the data store, step 105, and the user then retrieves or otherwise accesses their credential(s), step 110. An access control list or other access mechanism known in the art generally specifies security preferences regarding access to the data store. For example, the mail program and data store may support a plurality of users with each user having a specific folder in the data store containing that user's mail and to which only that user has access via a user ID and password or other similar means. In varying embodiments, users login manually themselves or automatically via a software agent as known in the art. Access to the user's mail, and thus also to their security credentials, is limited only to the user.

After access to the credentials is authorized, the credentials can then be used to initiate a security-related mail operation, step 115. For example, the credentials can be used as means to authenticate a sender and securely sign an e-mail. The credentials can also be used to encrypt a communication to protect against interception and ensure that only the intended recipient is able to decode the message. For example, in some embodiments, the credentials may include a user's security ID file or other file which includes not only the user's private key or public/private key pair, but also security certificates or cross-certificates associated with other users containing the public keys of those users or other similar security credentials known in the art which can be used to perform additional security-related operations. Thus, in some embodiments, the credentials can also be used to securely sign and encrypt a communication.

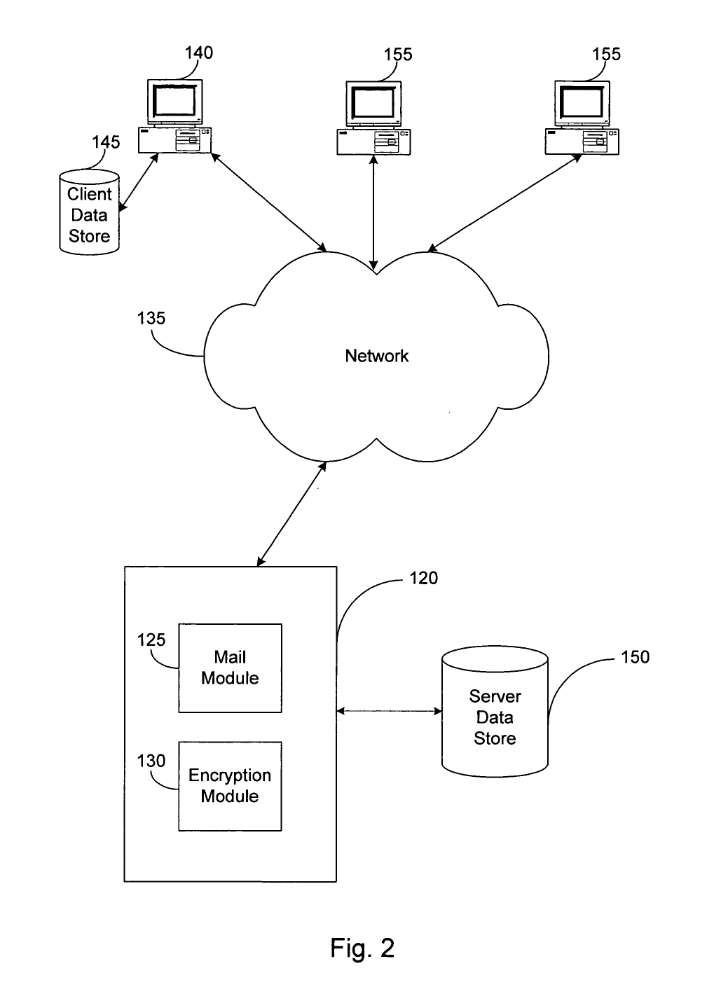

FIG. 2 presents a block diagram of a system for managing a user security credential according to an embodiment of the present invention. As shown, the system includes server data store 150 communicatively coupled to a mail server 120 executing a mail module 125 and an encryption module 130, a network 135, a user's personal client computer 140 communicatively coupled to a client data store 145, and one or more remote client computers 155.

The mail server 120 is generally a server or other general purpose computer executing a mail module 125 and an encryption module 130. The mail server 120 is connected to a network 135 such as a local area network (“LAN”), a wide area network (“WAN”), a wireless network, the Internet, an Intranet, or other type of network known in the art. A user's personal client computer 140 and one or more other client computers 155 communicate with the mail server 120 via the network 135. In some embodiments, the user's personal client computer 140 and client computers 155 send e-mail messages to the mail server 120 via the network 135.

The user's personal client 140 is generally the computer that the user would consider their primary computer. As previously discussed, in traditional PKI systems, the user's credentials would likely be stored locally in a client data store 145 communicatively coupled to the user's personal client 140. Indeed, in some embodiments, the user's credentials actually are stored locally in the client data store 145 as well as elsewhere in the system as further described herein.

At times, however, the user may also use other client computers 155 to access the network 135 and perform mail operations via the mail server 120. In some embodiments, these client computers 155 execute traditional mail client programs such as Lotus Notes or Microsoft Outlook, while in other embodiments the user performs mail operations via a browser or other means known in the art using the client computers 155.

The mail module 125 generally processes inbound and outbound electronic communications, such as e-mail messages. The encryption module 130 generally assists the mail module 125 to perform security-related mail operations such as signing, authenticating, encrypting, and decrypting e-mail messages and attachments. For example, in some embodiments the mail module 125, either alone or with the assistance of the encryption module 130, processes user requests from user client 140 and remote clients 155 to perform secure mail operations. The mail module 125 (or the encryption module 130) authenticates the user as described herein to permit access to the server data store 150 where the users credentials are stored in a mail database file for use by the system to perform security-related mail operations.

In some embodiments, the mail module 125 and the encryption module 130 are parts of the same program, for example a mail application such as Lotus Notes or Microsoft Outlook. In other embodiments, the mail module 125 and the encryption module 130 are parts of different programs, for example the mail module 125 might be a part of Microsoft Outlook and the encryption module 130 a part of a second program by a different manufacturer that merely interfaces with the mail program 125. Those skilled in the art will recognize that the mail module 125 represents an exemplary module and that the invention should not be construed as being limited in functionality or applicability to only mail-related applications since the systems and methods disclosed herein could equally be implemented by an operating system or other type of program directed to processing electronic communications and data.

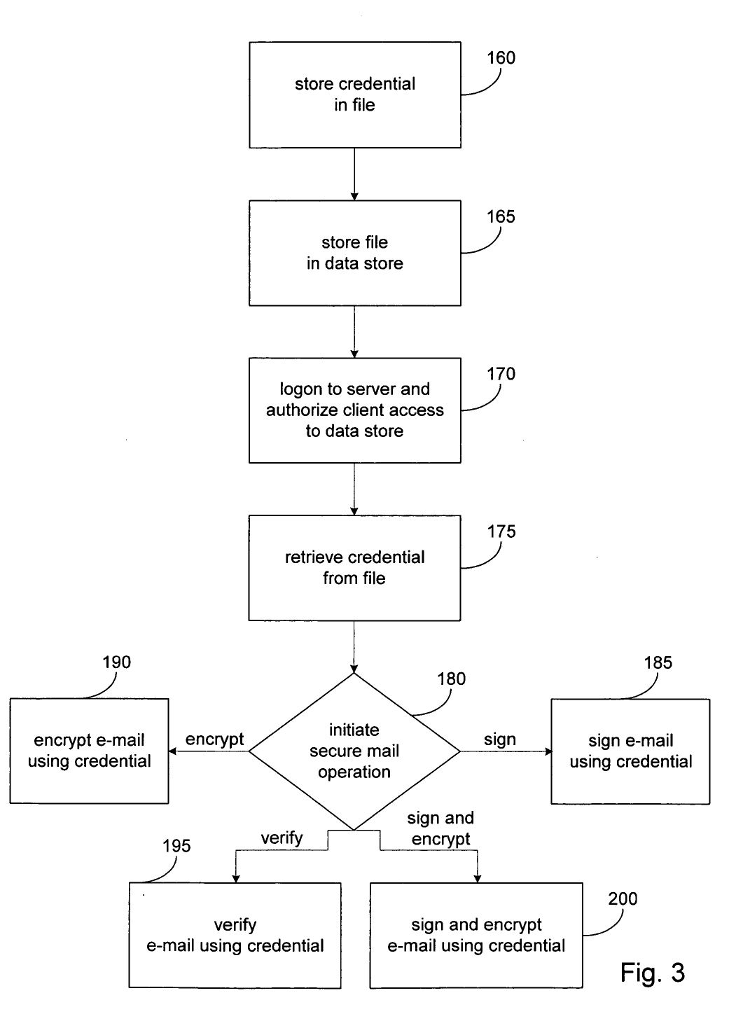

FIG. 3 presents a flow chart of a method for managing a user security credential according to an embodiment of the present invention. A user's credentials are stored in a file, step 160. As used in various embodiments disclosed herein, a file generally represents a container associated with an identifier indicating to the system that the container contains the user's credentials. In some embodiment's, the user's credentials are stored in a named e-mail contained in the mail data store. As used in various embodiments disclosed herein, a named e-mail generally represents an e-mail associated with an identifier indicating to the system that e-mail contains the user's credentials. For example, the subject line of the e-mail may contain text or other information which the system can use as a search token to locate the user's credential. Alternatively, in other embodiments, the identifier may be contained in the header of the e-mail or in the body of the e-mail itself. In some embodiments, the mail module or the encryption module generates the credentials and automatically stores the credentials in the file. In other embodiments, the mail module or the encryption module (or another module executing on the user's client) prompts the user to identify previously generated credentials and stores these credentials in the file.

The system stores the file in the server data store, step 165. The file (and the credentials it contains) is thus available to. the user whether the user is performing mail operations at their primary computer or at a different remote client computer. In some embodiments, the file is stored in the server data store automatically by the mail module or the encryption module. For example, when the credentials are generated or stored in the file, the system then stores the file in the server data store. Alternatively, in other embodiments, a user may elect to mail or otherwise transmit and store the file directly into the server data store.

When a user (or a user's program or software agent, etc.) wishes to use the credentials stored in the file, the user must first logon to the mail server or otherwise authorize user client access to the server mail data store containing the file as previously described herein, step 160. The system then initiates a secure mail operation as required, step 180. In some embodiments, the user's credentials are communicated to the remote client for use in performing the mail operation. For example, in the case of a remote client executing a stand-alone mail client application as opposed to a virtual mail client, the client application may require that the credentials be available locally on the remote client to perform the secure mail operation. In other cases, clients may access the credentials via the mail server to perform the secure mail operation, for example, with the assistance of the server's mail module or encryption module. Thus, the system uses the credentials as appropriate to sign the e-mail, step 185, encrypt the e-mail, step 190, verify the e-mail, step 195, or sign and encrypt the e-mail, step 200.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for managing a user security credential, the method comprising:
storing, in a file contained in a data store communicatively coupled to a mail server, a security credential associated with a user;
authorizing a client to access the data store according to an access permission associated with the user;
retrieving the security credential from the file; and
initiating a security-related mail operation from the client using the security credential without the security credential leaving the mail server.

2. The method of claim 1, wherein storing in a file comprises storing in an electronic mail message.

3. The method of claim 2, wherein storing in an electronic mail message comprises storing in a named electronic mail message.

4. The method of claim 1, wherein storing in a file comprises storing in an attachment file associated with the data store.

5. The method of claim 1, wherein storing in a file comprises storing in a file containing an identifier indicating that a security credential is stored in the file.

6. The method of claim 1, wherein storing a security credential associated with a user comprises storing a private key associated with a user.

7. The method of claim 1, wherein storing a security credential associated with a user comprises storing a digital certificate associated with a user.

8. The method of claim 1, wherein storing a security credential associated with a user comprises storing a cross-certificate associated with a user.

9. The method of claim 1, wherein authorizing a client comprises authorizing a remote mail client.

10. The method of claim 9, wherein authorizing a remote mail client comprises authorizing a remote mail client operating via a browser.

11. The method of claim 1, wherein retrieving the security credential comprises parsing the file to retrieve the security credential.

12. The method of claim 1, wherein initiating a security-related mail operation comprises signing an electronic mail message.

13. The method of claim 1, wherein initiating a security-related mail operation comprises encrypting an electronic mail message.

14. The method of claim 1, wherein initiating a security-related mail operation comprises verifying an electronic mail message.

15. A system for managing a user security credential, the system comprising:
a file containing a security credential associated with a user;
a data store containing the file and communicatively coupled to a mail server;
an electronic mail program executing on the mail server; and
a client computer;
wherein the electronic mail program is programmed to:
authorize the client computer to access the data store according to an access permission associated with the user;
retrieve the security credential from the file; and
initiate a security-related mail operation from the client using the security credential without the security credential leaving the server.

16. The system of claim 15, wherein the file comprises an electronic mail message.

17. The system of claim 16, wherein the electronic mail message comprises a named electronic mail message.

18. The system of claim 15, wherein the user security credential is stored in an attachment file associated with the file.

19. The system of claim 15, wherein the file contains an identifier indicating that a security credential is stored in the file.

20. The system of claim 15, wherein the security credential comprises a private key associated with a user.

21. The system of claim 15, wherein the security credential comprises a digital certificate associated with a user.

22. The system of claim 15, wherein the security credential comprises a cross-certificate associated with a user.

23. The system of claim 15 wherein the client computer comprises a remote mail client.

24. The system of claim 23, wherein the remote mail client comprises a remote mail client operating via a browser.

25. The system of claim 15, wherein the electronic mail program is programmed to retrieve the security credential by parsing the file.

26. The system of claim 15, wherein the security-related mail operation comprises signing an electronic mail message.

27. The system of claim 15, wherein the security-related mail operation comprises encrypting an electronic mail message.

28. The system of claim 15, wherein the security-related mail operation comprises verifying an electronic mail message.

29. A computer usable medium or media storing program code which, when executed on a computerized device, causes the computerized device to execute a method for managing a user security credential, the method comprising:
storing, in a file contained in a data store communicatively coupled to a mail server, a security credential associated with a user;
authorizing a client to access the data store according to an access permission associated with the user;
retrieving the security credential from the file; and
initiating a security-related mail operation from the client using the security credential without the security credential leaving the server.

30. The computer usable medium or media of claim 29, wherein storing in a file comprises storing in an electronic mail message.

31. The computer usable medium or media of claim 29, wherein storing in an electronic mail message comprises storing in a named electronic mail message.

32. The computer usable medium or media of claim 29, wherein storing in a file comprises storing in an attachment file associated with the data store.

33. The computer usable medium or media of claim 29, wherein storing in a file comprises storing in a file containing an identifier indicating that a security credential is stored in the file.

34. The computer usable medium or media of claim 29, wherein storing a security credential associated with a user comprises storing a private key associated with a user.

35. The computer usable medium or media of claim 29, wherein storing a security credential associated with a user comprises storing a digital certificate associated with a user.

36. The computer usable medium or media of claim 29, wherein storing a security credential associated with a user comprises storing a cross-certificate associated with a user.

37. The computer usable medium or media of claim 29, wherein authorizing a client comprises authorizing a remote mail client.

38. The computer usable medium or media of claim 36, wherein authorizing a remote mail client comprises authorizing a remote mail client operating via a browser.

39. The computer usable medium or media of claim 29, wherein retrieving the security credential comprises parsing the file to retrieve the security credential.

40. The computer usable medium or media of claim 29, wherein initiating a security-related mail operation comprises signing an electronic mail message.

41. The computer usable medium or media of claim 29, wherein initiating a security-related mail operation comprises encrypting an electronic mail message.

42. The computer usable medium or media of claim 29, wherein initiating a security-related mail operation comprises verifying an electronic mail message.
